(19) United States
(12) Patent Application Publication
(10) Pub. No.: US 2023/0244184 A1
(43) Pub. Date: Aug. 3, 2023

(54) REPLICATION TOOLING

(71) Applicant: ACR II GLASS AMERICA INC., Nashville, TN (US)

(72) Inventors: Markus Walter Pohlen, Mückeln (DE); Steven Scott Christman, Nashville, TN (US); Emily Anne Curtis, Nashville, TN (US); Yu Matsuda, Nashville, TN (US)

(21) Appl. No.: 17/773,126

(22) PCT Filed: Oct. 30, 2020
(86) PCT No.: PCT/US2020/058252

§ 371 Date: Apr. 29, 2022

Related U.S. Application Data
(60) Provisional application No. 62/929,458, filed on Nov. 1, 2019.

(51) Int. Cl. G03H 1/02

(52) U.S. Cl. CPC G03H 1/0276; G03H 2250/37; G03H 2270/11; G02B 27/0103

(57) ABSTRACT

A replication tool for use in preparing a holographic film by replication, comprising a base structure having a structure body and a channel configured to receive at least one of a laminated glazing and a master holographic film assembly.

### CROSS REFERENCE TO RELATED APPLICATION

This application claims priority to U.S. Provisional Application No. 62/929,458 filed on Nov. 1, 2019, entitled “REPLICATION TOOLING”, the entire contents of which are incorporated by reference herein in their entirety.

### TECHNICAL FIELD

The present disclosure generally relates to tooling used for replication of a holographic film, particularly in a film laminated between glass substrates.

### BACKGROUND

Head-up displays (HUDs) are used in vehicles to project an image which a driver may see Without looking away from the vehicle windshield. Particularly, HUD typically include a projector and reflect a projected image from a windshield to provide an image for a driver. However, a windshield has two reflective surfaces in the inner and outer glass surfaces which may each create a reflected image. One of the reflected images may be weaker and is known as a “ghost image” which may lead to the driver perceiving a hazy or double image.

Wedge-shaped interlayers have been used to align the images by adjusting the reflective point of the “ghost image” to match the reflection of the stronger image, creating a single image for the driver. However, a wedge-shaped interlayer is not adjustable and the images may be aligned only for drivers at a particular height. There is a need in the art for windshields having HUD capabilities for drivers with a range of heights.

One possible solution is to use a p-polarized projector and a laminated film which reflects p-polarized light. Being near the Brewster angle, the glass surface reflections will not generate ghost images. Another possible solution is to use a p- or s-polarized projector and a laminated film comprising a halfwave retarder. Being near Brewster angle, depending on the projector light polarization, only the inner or outer glass surface may reflect light. Laminating a film however may have the problem of short range deviations of the reflecting film surface which cause distortions in the HUD image.

There is a desire for HUD systems with larger HU images which would need large projector apertures which are limited by available space in the vehicle dashboard. By using a holographic film which has focusing power (i.e. concave mirror feature), smaller projector sizes can be used.

A HUD construction may include a holographic film which provides a projected image to the driver. The holographic film may be laminated to or in a glazing, as described in Manfred-Andreas Beeck et al. Holographic mirrors laminated into windshields for automotive Head-Up Display and solar protective glazing applications, 1507 Proc. SPIE 394 (1991). However, laminating the film may cause particular difficulties, such as placement and curvature of the holographic film, as well as small scale deviations or unevenness in the film. There is a need in the art for a solution to at least these difficulties, among others.

One method of the holographic film may be commonly executed in two steps using a flat master hologram and a flat photosensitive polymer to provide a flat holographic film. First, a master hologram is generated by recording an interference pattern in a thin film of photosensitive polymer. Second, this master hologram is replicated in the hologram films as described in Friedrich-Karl Bruder, et al., Mass Production of Volume Holographic Optical Elements (vHOEs) using Bayfol® HX Photopolymer Film in a Roll-to-Roll Copy Process, 10127 Proc. SPIE 101270A (2017). Where these holographic films are laminated in the glazing, deviations in the holographic film from its nominal form resulting, from lamination may be visible in the HUD image.

### SUMMARY OF THE DISCLOSURE

Disclosed herein is a replication tool for use in preparing a holographic film by replication, including a base structure having a structure body and a channel configured to receive at least one of a laminated glazing and a master holographic film assembly.

In some embodiments, the base structure serves as a separator located between the laminated glazing and the master holographic film assembly during use. In another embodiment, the base structure may include a port for attachment to a vacuum, which may be used to deair a space between the laminated glazing and master holographic film assembly closely assembled.

In another aspect of this disclosure, a method of preparing a laminated glazing may including using the replication tool around at least one of the laminated glazing and the master holographic film assembly and aligning the glazing and the assembly for replication. Replication may include applying a reactive light to a photopolymer film within the laminated glazing through the master holographic film assembly. In some methods, an index matching material may be provided in a space between the laminated glazing and the master holographic film assembly.

### BRIEF DESCRIPTION OF THE DRAWINGS

The accompanying drawings, which are incorporated and constitute a part of this specification, illustrate one or more example aspects of the present disclosure and, together with the detailed description, serve to explain their principles and implementations.

FIG. 1 illustrates a laminated glazing with tooling for a replication process, according to an exemplary embodiment of the present disclosure;

FIG. 2 illustrates a cross section of a laminated glazing with tooling for a replication process across line A-A′, according to an exemplary embodiment of the present disclosure;

FIG. 3 illustrates a cross section of a laminated glazing and a master holographic film assembly with a tooling for a replication process across line A-A′, according to an exemplary embodiment of the present disclosure

FIG. 4 illustrates a cross section of a laminated glazing and a master holographic film. assembly with a tooling for a replication process across line A-A′, according to an exemplary embodiment of the present disclosure;

FIG. 5 illustrates a cross section of a tool for use during replication across line A-A′, according to an exemplary embodiment of the present disclosure;

FIG. 6 illustrates a cross section of a tool for use during replication across line A-A′, according to an exemplary embodiment of the present disclosure; and

FIG. 7 illustrates a cross section of a laminated glazing and a master holographic film assembly with a tooling for a replication process across line A-A′, according to another exemplary embodiment of the present disclosure.

### DETAILED DESCRIPTION

Disclosed herein are exemplary aspects of replicating tools for replicating a holographic film in a laminated glazing from a master holographic film. In the following description, for purposes of explanation, specific details are set forth in order to promote a thorough understanding of one or more aspects of the disclosure. It may be evident in some or all instances, however, that many aspects described below can be practiced without adopting the specific design details described below.

Laminated glazings having a film laminated therein may particularly be formed by laminating a first glass sheet, a first interlayer, a film, a second interlayer and a second glass sheet. Preferably, the first and second interlayers may be an adhesive material, such as a polymer adhesive sheet, including a polyvinyl butyral (PVB), ethylene vinyl acetate (EVA), or an ionomer. In some embodiments, the first and/or second interlayers may be a thin adhesive layer Which may be formed on a glass sheet or the laminated film. Laminated films may be particularly useful for a HUD compatible glazing, including, for example, a holographic film which may be used in combination with a projector to provide an image viewable to a driver. Holographic films may be further used in other applications, such as lighting introduction to and/or extraction from a glazing or as anisotropic transmissive elements for solar protection. Laminated glazings may have any suitable application, including those for a vehicle, such as a windshield, sunroof, back window, or side window. Laminated glazings, including those with a film laminated therein, may be bent to have a desired shape for the glazing application.

In some laminated glazings, a laminated film may have small scale deviations or unevenness in the film. The deviations may be visible as light transmitting through the glazing is scattered by a changing angle and displacement of the film. The curvature of a glazing and the lamination process may contribute to the formation of such film properties as the film takes the shape of the glazing during lamination. Where a laminated film, such as a holographic film, is used for HUD, the deviations may be visible in the virtual HUD image diffracted by the holographic film.

A holographic film which may be laminated in a glazing for HUD applications may be prepared by a replication process. Typical replication processes may include positioning a master holographic film to a photopolymer film and applying a reactive light to the photopolymer thin through the master holographic film. Where the replication is completed prior to lamination, the photopolymer film may be flat or substantially flat during replication. During lamination, the replicated photopolymer film may form deviations or other changes in the film structure which may locally wrinkle or otherwise alter the film structure. Further, high temperature and pressure during the autoclaving process may alter the Bragg grating in the hologram resulting in deviations in the designed hologram features as reflected wavelengths and angles. It may be preferable to replicate holographic film in a laminated glazing such that the replication is performed over any deviations in the already laminated photopolymer film.

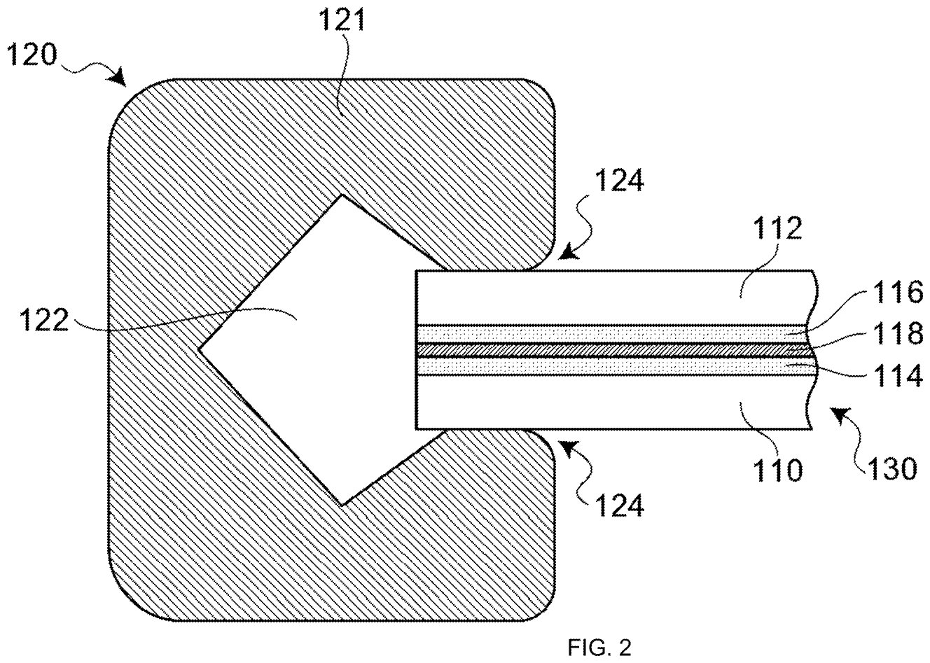

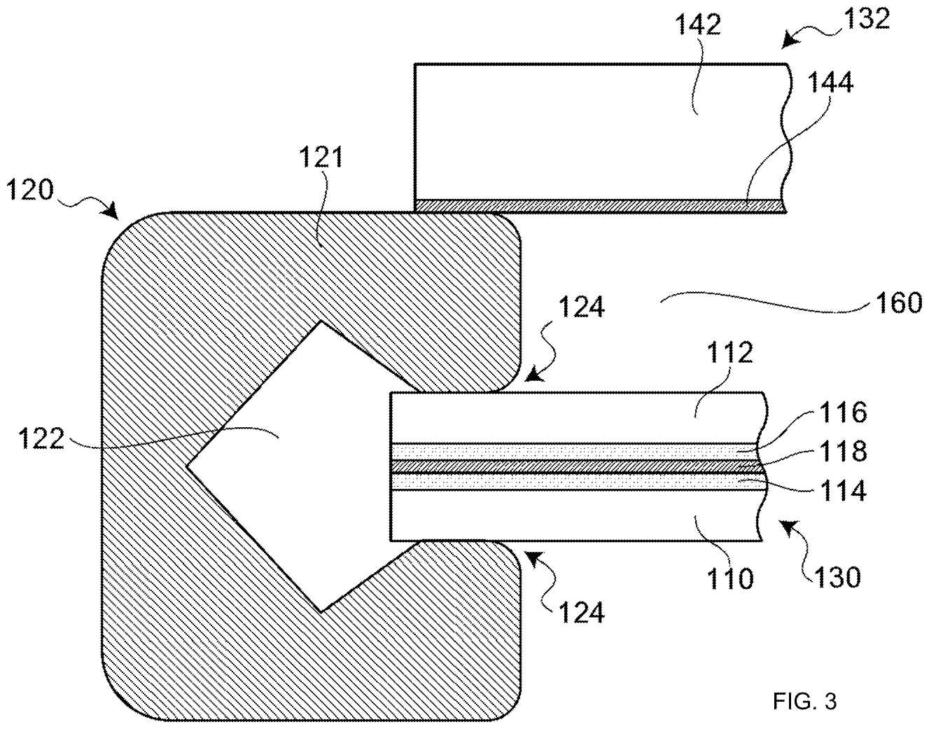

To provide a laminated holographic film which may not display deviations of the film in a diffracted image, the holographic film may be replicated, or recorded, in a laminated glazing. Particularly, a photopolymer film may be laminated between at least two substrates, such as glass sheets. Such a laminated construction 130 may include, as shown in FIG. 2, a first glass sheet 110, a first interlayer 114, a photopolymer film 118, a second interlayer 116, and a second glass sheet 112. The photopolymer film 118 within the glazing 130 may be treated with a light beam and a master holographic film alter lamination such that the photopolymer film 118 may be recorded on to provide a holographic film based on the master holographic film. Particularly, the master holographic film may be aligned with the photopolymer film 118, at least in a region for HUD use in the laminated glazing 130. In some embodiments, the master holographic film may have the same or substantially the same shape as the laminated glazing 130 and may be positioned on a support having the same shape as the laminated glazing. The master holographic film 144 and its support 142, as shown in FIG. 3, are collectively referred to herein as a master holographic assembly 132.

Once the master holographic film 144 is aligned with the laminated glazing 130, a light to which the photopolymer film 118 is reactive may be applied to the photopolymer film 118 through the master holographic film 144. Particularly, a master film support 142 may be transparent to the reactive light used during replication. After the photopolymer film 118 is treated with the reactive light, the glazing 130, including the photopolymer film 118 may be treated with a bleaching light such that the photopolymer film 118 is no longer reactive to the reactive light. In some embodiments, the reactive light may have a wavelength in the range of 200 nm to 780 nm, more preferably 300 nm to 700 nm, and even more preferably from 380 nm to 680 nm.

The photopolymer may include any suitable material capable of recording holograms or particularly, volume holographic optical elements (VOEs), by optical polymerization of monomers and oligomers. A photopolymer may include polymerizing monomers, photopolymerization initiators, and matrix polymers. Polymerizing monomers may include at least one of functional (meth) acrylate, functional (meth) acrylamide, functional (meth) acrylonitrile, and functional (meth) acrylic acid. Generally known photopolymerization initiators may be used without any material limitation and, for example, may include monomolecular initiators bimolecular initiators. Monomolecular initiators may include, for example, triazine, benzophenone, benzoin, and benzyl ketal. Matrix polymers may include, for example, polyurethanes, polyacrylates, and polymethylmethacrylates. A photopolymer film used herein may include, for example, Bayfol (Registered trademark) HX made of Covestro LCC.

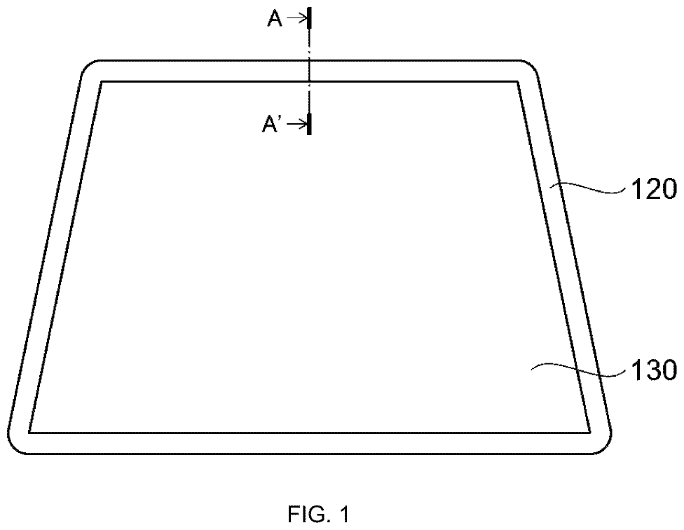

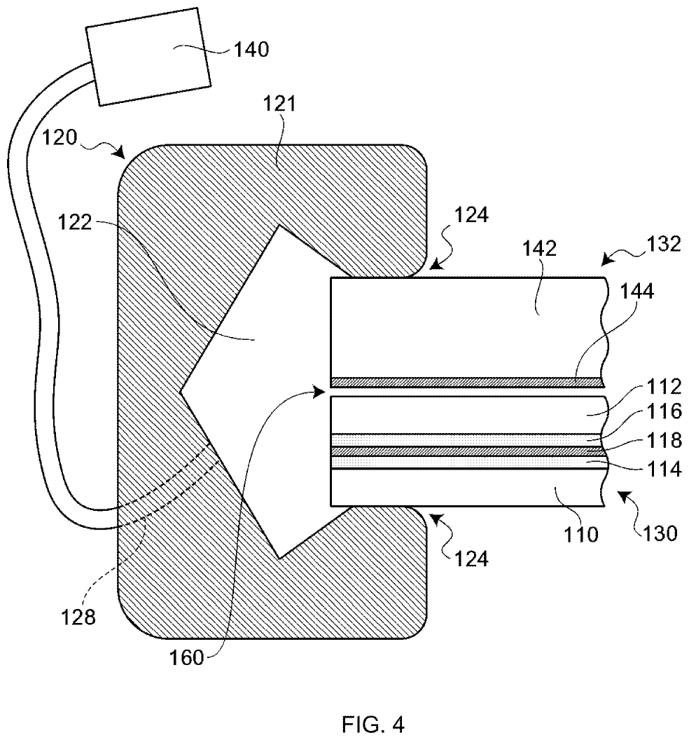

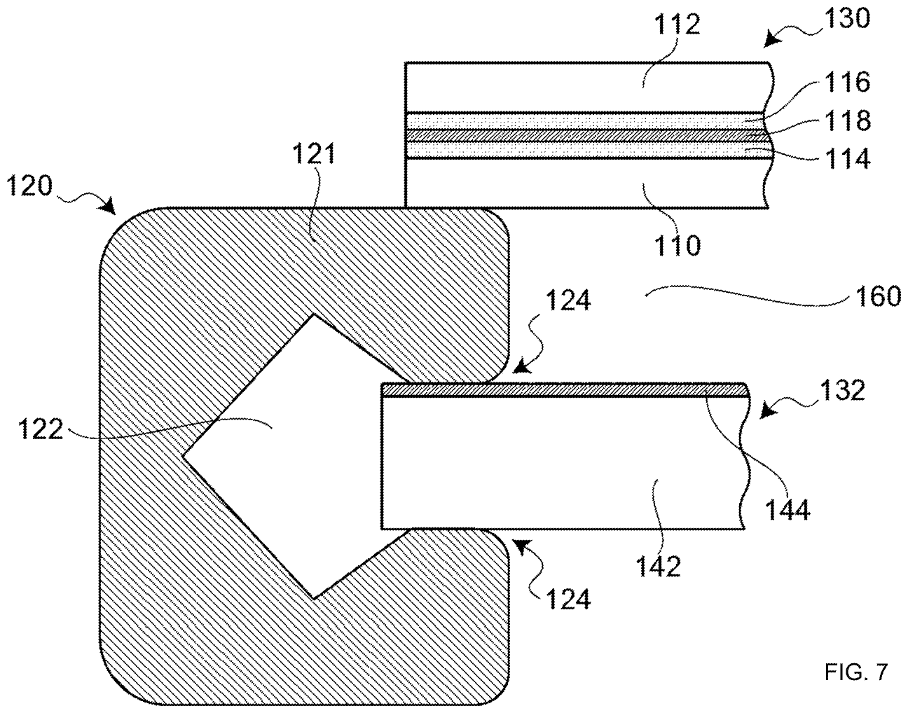

The replication process may be sensitive to vibrations or other interruptions between the laminated glazing 130 and the master holographic film assembly 132 during light application. Thus, some tooling disclosed herein may be desirable to dampen or avoid vibrations between a laminated glazing 130 and a master holographic film assembly 132. The tooling may include a base structure 120 shaped to fit around at least one of the laminated glazing 130 and the master holographic film assembly 132. The base structure 120 may include a structure body 121 and a channel 122 formed in the structure body 121. As shown in FIG. 1, the base structure 120 may extend along the outer periphery of the laminated glazing 130 to be fabricated. In further embodiments, the base structure 120 may alternatively or additionally extend along the outer periphery of the master holographic film assembly 132. The channel 122 of the base structure 120 may be formed to receive the laminated glazing 130 as shown in FIGS. 2 and 3. When the base structure 120 is positioned on the laminated glazing 130, there may remain space between the structure body 121 and the laminated glazing 130 in the channel 122. As shown in FIG. 3, an outside surface of the base structure 120 may be employed as a contact area for contacting the master holographic film assembly 132 during replication. In some other embodiments, the channel 122 of the base structure 120 may be formed to receive the master holographic film assembly 132 as shown in FIG. 7. In the tooling shown in FIG. 7, an outside surface of the base structure 120 may provide a contact area for contacting the laminated glazing 130 during replication. In some embodiments, the base structure 120 may fit around both the laminated glazing 130 and the master holographic film assembly 132, as shown in FIG. 4. A space between the laminated glazing 130 and the master holographic film assembly 132 may be adjusted by removing air from the space. De-airing may be achieved by a vacuum 140 applied through the channel 122, wherein the channel 122 may extend around the outer periphery of the laminated glazing 130 and the master holographic film assembly 132. The channel 122 may be connected to a vacuum 140 for reducing internal pressure in the channel 122 and the space between the laminated glazing 130 and the master holographic film assembly 132. The structure body 121 way include a port, or opening, 128 for connection to the vacuum 140.

During replication, the base structure 120 may fit along the periphery of at least one of the laminated glazing and the master holographic film assembly. The base structure 120 may help to stabilize the laminated glazing 130 as related to the master holographic film assembly 132 and maintain a consistent distance between the laminated glazing 130 and the master holographic film assembly 132. The base structure 120 may be formed to provide stability in the replication process based on its structure and size. Further, the base structure 120 may be formed to interact with a base unit Which may further dampen vibrations. For example, the base structure 120 may be fitted around a laminated glazing 130 and/or a master holographic film assembly 132 and then be positioned in a receiving unit during replication.

The distance between a surface of the laminated glazing 130 and a surface of the master holographic film assembly 132 facing each other may include a maximum and a minimum distance across the glazing 130 and the assembly 132. Preferably, a difference between the maximum and. minimum distances is from 0 mm to 6.0 mm, more preferably from 0 mm to 3.0 mm, and even more preferably from 0 mm to 2.0 mm. During, replication, a light source may be applied to the laminated photopolymer film 118 through the master holographic film 144. The distance between the photopolymer film 118 and the master holographic film 144, and thus the distance between the laminated glazing 130 and the master holographic film assembly 132, may affect a tolerance associated with the application of the reactive light source, including an angle tolerance of light application. Thus, it may be beneficial to control for the distance between the laminated glazing 130 and the master holographic film assembly 132. Preferably, the distance between the laminated glazing 130 and the master holographic film assembly 132 may change at a rate from 0 mm to 1.0 mm over 100 mm across the glazing 130 and the assembly 132 and more preferably from 0 mm to 0.7 mm over 100 mm.

A base structure 120 for tooling described herein may be formed of any suitable material, including elastic materials, such as EPDM rubber (ethylene propylene diene monomer rubber), rubber, or silicone. A suitable elastic material may include a silicone based material or an ethylene propylene diene terpolymer based material. The material may preferably be flexible enough that the base structure 120 may be fitted around at least one of the laminated glazing 130 and the master holographic film assembly 132. The base structure 120 may be formed having a channel 122 extending from an edge of the base structure 120 which may receive at least one of the glazing 130 and the assembly 132. When the laminated glazing 130 and/or the master holographic film assembly 132 are positioned within the channel 122, the channel 122 may also include a space within the base structure 120. The channel 122 may have any suitable shape and may be formed to improve flexibility of the structure such that it may be easily handled, including for receiving a glazing 130 or assembly 132 and removing the base structure 120 after replication. In some embodiments, the base structure 120 may be formed as a ring, wherein the elastic material may be welded to itself to form a ring shape. In some embodiments, corners may be formed in the base structure 120 by suitable means, such as welding, such that the structure may it closely to the shape of the laminated glazing 130 and/or the master holographic film assembly 132. When fitted to the glazing 130 and/or the assemble 132, a seal 124 may be created between the base structure 120 and the laminated glazing 130 and/or master holographic film assembly 132 as shown in FIG. 2. As shown FIGS. 2, 3, 4, and 7, the seal 124 may be formed between the base structure 120 and each of opposing surfaces of the glazing 130 and/or the assembly 132 positioned within the channel

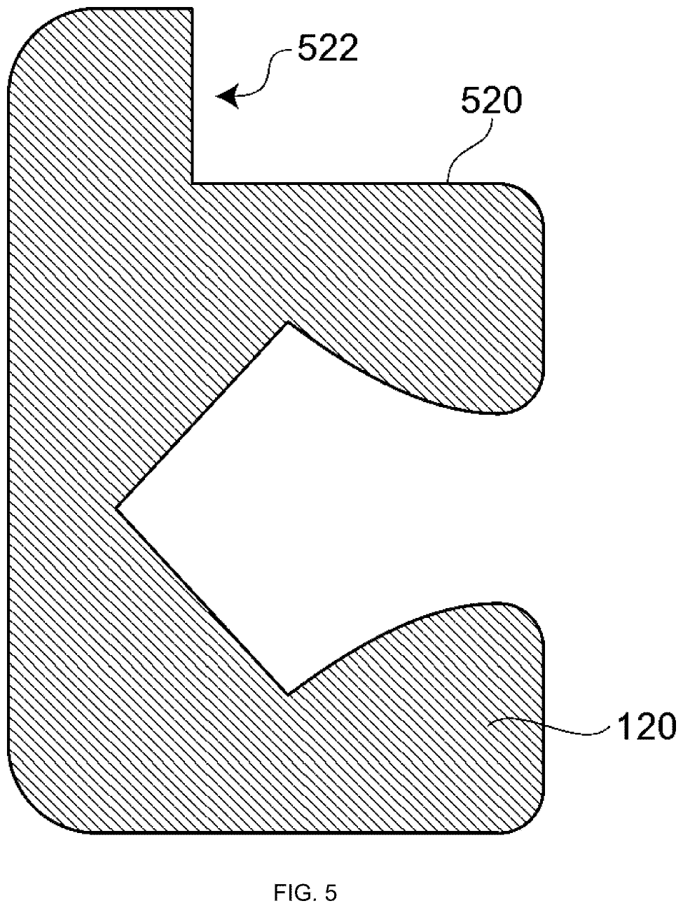

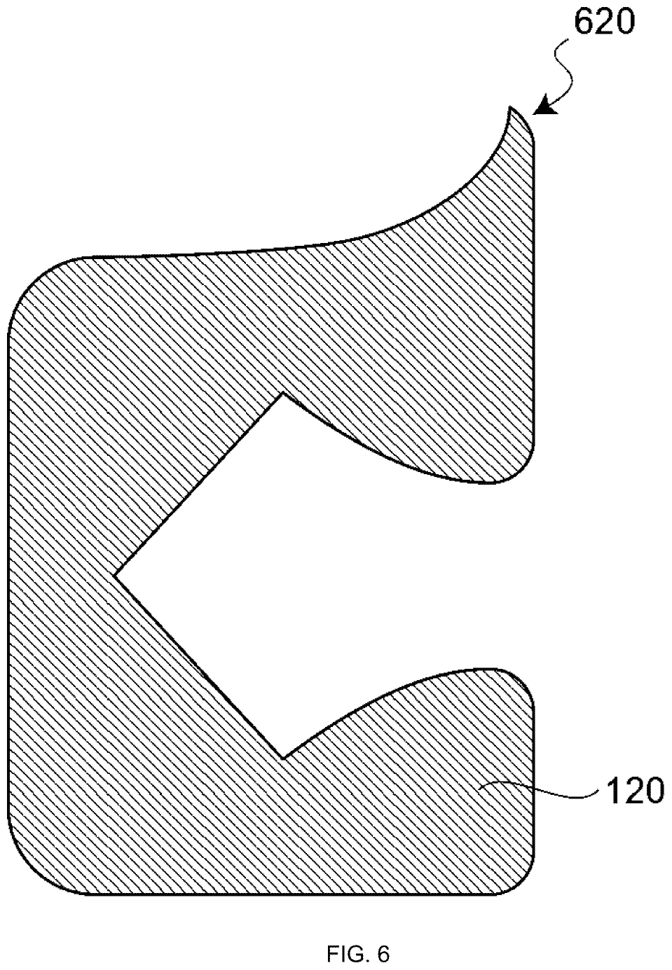

In some embodiments, as shown in FIGS. 2, 3, and 7, the base structure 120 may be formed around one of the laminated glazing 130 and the master holographic him assembly 132. When fitted around one of the glazing 130 and the assembly 132, the base structure 120 may create a separator between the laminated glazing 130 and the master holographic film assembly 132 which may provide a consistent or substantially consistent distance between the glazing 130 and the assembly 132. The base structure 120 may be formed to provide a desired shape or surface for aligning the laminated glazing 130 and the master holographic film assembly 132, as shown in FIGS. 3 and 7. For example, the base structure 120 may have a flat or curved surface which may provide a contact area for one of the glazing 130 or the assembly 132 which is not fitted within the base structure 120 and the channel 122. Some embodiments may include an outer lip portion 522, providing a shelf 520 for the placement of the glazing 130 or assembly 132, as shown in FIG. 5. The shelf (flat portion) 520 and lip portion 522 may improve processing to provide accurate placement of the glazing 130 or assembly 132 and the correct positioning of a holographic film replication. In some embodiments, the lip portion 522 and shelf 520 may provide a tight fit around. the glazing 130 or assembly 132. Further embodiments, as shown in FIG. 6, may include an extension or flange 620 on the base structure 120 which may provide a point of contact for the glazing 130 or assembly 132. For example, where the laminated glazing 130 is positioned in the base structure 120, the master holographic film, assembly 132 may be positioned against the base structure 120 at the point of contact, which may include the extension or flange 620. The distance between the master holographic film assembly 132 and the laminated glazing 130 may be controlled in part by the base structure 120 and its shape, including how a master holographic film assembly 132 or laminated glazing 130 flay be positioned against the base structure 120.

During replication, it may be desirable to include an index matching material in a void 160 between the laminated glazing 130 and the master holographic film assembly 132. The void 160 may include space between the glazing 130 and assembly 132, spanning the distance between the glazing 130 and the assembly 132. An index matching material may decrease reflections of a reactive light during replication and improve the quality of a replicated film in the laminated glazing 130. Particularly, an index matching material may be an oil or a gel. The base structure 120 may provide a lip around one of the laminated glazing 130 and the master holographic film assembly 132 above the seal 124, such that the index matching material is contained between the glazing 430 and the assembly 132. A laminated glazing 430 edge and periphery area may not be exposed to the index matching material, which may protect the lamination materials and a portion of the laminated glazing 130 which is glued into a vehicle during installation from exposure to the index matching material. In some embodiments, an index matching material may affect the adhesion of a glue used during glazing installation, and it may be preferable to protect an area of the glazing 130 to be glued from the index matching material with the replication tooling described herein. Particularly, the index matching material may not reach past the seal 124 formed at the base structure 120 and a periphery of the glazing 130 may remain free of exposure to the index matching material.

Where a vacuum is applied to the channel 122, a vacuum port 128 from which the vacuum may pull air may pass through the structure body 121 to the channel 122. Particularly, where the base structure 120 fits around both a laminated glazing 130 and the master holographic film assembly 132 a vacuum 140 applied to the base structure 120 may draw air from between the glazing 130 and the assembly 132, decreasing the distance between the materials. The vacuum 140 may particularly be connected to the base structure 120 at the port 128 in the structure. The channel 122 may include air between the base structure 120 and a laminated glazing 130 and master holographic film assembly 132 extending in an area with the base structure 120 around the outer edge of the glazing 130 and assembly 132. The vacuum 140 may pull air from the channel 122 at the edge of the glazing 130 and assembly 132. In some embodiments, the vacuum 140 may be used in combination with index matching materials between the glazing 130 and the assembly 132.

In some embodiments, a base structure 120 may farther be used for deairing during preparation of the laminated glazing 130. For example, a base structure 120 may be positioned around a stack of lamination materials and attached to a vacuum 140 which may remove air from between the layers of the stack. The stack of lamination materials may include a first glass sheet 110, a first interlayer 114, a photopolymer film 118, a second interlayer 116, and a second glass sheet 111 The stack for lamination may then be autoclaved. The base structure 120 may remain on the stack through the autoclave cycle and during a replication process thereafter. Where the base structure 120 remains around the stack during an autoclave process, the base structure 120 may preferably be stable at high temperatures. Preferably, the base structure 120 may withstand temperatures of at least 100° C., more preferably at least 125° C., and even more preferably at least 145° C. The base structure 120 as described herein may further be used with laminated glazings prepared using any deairing process, including press rollers and vacuum bag cleaning.

FIG. 7 shows another embodiment in which the positions of the master holographic film assembly and the laminated glazing are interchanged with, each other in comparison with the structure shown in FIG. 3, wherein the base structure 120 has a channel 122 for fitting only the master holographic film assembly 132. The base structure 120 may have a contact area formed at an outer surface of the base structure 120 where the lamented glazing 130 may sit during the replication process.

Replication using the replication tooling may include aligning the laminated glazing 130 and the master holographic film assembly 132.

In some methods of using the tooling described herein, the base structure 120 may be provided on a periphery of the laminated glazing 130 having, a photopolymer film 118 formed inside. The laminated glazing 130 may include a first glass 110, a first interlayer, 114 the photopolymer film 118, a second interlayer 116, and a second glass 112. The base structure 120 may extend along the entire periphery of the laminated glazing 130. That is, where the laminated glazing 130 extends in a trapezoid shape with curved edges, the base structure 120 may extend along the entire periphery of the trapezoid-shaped laminated glazing 130. The laminated glazing 130 with the base structure 120 may be prepared by preparing a laminated glazing 130 with the photopolymer film 118 formed therein and attaching the base structure 120 around the laminated glazing 130 after preparing the laminated glazing 130. In another embodiment, the laminated glazing 130 with the base structure 120 may be prepared by preparing a stack of the first glass 110, the first interlayer 114, the photopolymer film 118, the second interlayer 116, and the second glass 112, attaching the base structure 120 around the stack, deairing the stack, and autoclaving the stack after deairing to provide a laminated glazing 130 for aligning with the master holographic film assembly 132 for a replication process.

The master holographic film assembly 132 may be aligned with the laminated glazing 130 held in the base structure 120. In FIG. 3, the master holographic film assembly 132 is shown contacting outer surface of the base structure 120 which may maintain a distance between the laminated glazing 130 and the master holographic film assembly 132. The laminated glazing 130 may be positioned above or below the master holographic film assembly 132 during replication. The light source may be positioned such that the master holographic film assembly 132 is between the light source and the laminated glazing 130. The photopolymer film 118 may then undergo replication by the radiation of a reactive light through the master holographic film assembly 132 to the photopolymer film 118. The laminated film 118 may further be subject to a bleaching light to ensure the film 118 is no longer reactive and may retain the intended holographic pattern. After replication of the photopolymer film 118, the master holographic film assembly 132 and the base structure 120 may be separated from the laminated glazing 130.

In another method, the base structure 120 may be prepared around the master holographic film assembly 132. The channel 122 in the base structure 120 may be provided on the periphery of the master holographic film assembly 132 as shown in FIG. 7. The laminated glazing 130 may be prepared including a first glass 110, a first interlayer, 114 the photopolymer film 118, a second interlayer 116, and a second glass 112. The laminated glazing 130 may be aligned to the master holographic film assembly 132 and may include contact with the base structure 120. In FIG. 7, the laminated glazing 130 sit against the outer surface of the base structure 120 which maintains a distance between the laminated glazing 130 and the master holographic film assembly 132. The laminated glazing 130 may be positioned above or below the master holographic film assembly 132 during replication. The light source may be positioned such that the master holographic film assembly 132 is between the light source and the laminated glazing 130. The photopolymer film 118 may then undergo replication with the application of a reactive light through the master holographic film assembly 132. A bleaching light may then be directed to the laminated film 118 rendering the photopolymer film 118 no longer reactive to a reactive light and maintaining its holographic pattern.

In some other embodiments, both of the laminated glazing 130 and the luster holographic film assembly 132 may be positioned in the channel 122 of the base structure 120 during replication as shown in FIG. 4. With this method, a vacuum 140 may be attached to the base structure 120 for removing air that may remain between the laminated glazing 130 and the master holographic film assembly 132. The laminated glazing 130 may be positioned above or below the master holographic film assembly 132 during replication. The light source may be positioned such that the master holographic film assembly 112 is between the light source and the laminated glazing 130. A reactive light may be applied to the photopolymer film 118 within the laminated glazing 130 through the master holographic film 144 to provide a desired holographic pattern in the laminated film 118, and a bleaching light may be applied to the laminated glazing 430 to prevent further reaction of the film 148 to retain the holographic pattern.

In some embodiments, according to any of the methods disclosed, an index matching material may be provided between the laminated glazing and the master holographic film assembly before replication.

In the description above, for purposes of explanation and not limitation, the examples with. specific details are set forth to provide a thorough understanding of the present disclosure. However, it will be apparent to those having ordinary skill in the art that other embodiments with various modifications and variations may be practiced without departing from the spirit and scope of the present disclosure.

Furthermore, although elements of the described aspects and/or embodiments may be described or claimed in the singular, the plural is contemplated unless limitation to the singular is explicitly stated. Additionally, all or a portion of any aspect acid/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A replication tool for use in preparing a holographic film by replication, comprising:
a base structure having:
a structure body; and
a channel configured to receive at least one of a laminated glazing and a master holographic film assembly.

2. The replication tool according to claim 1, wherein the channel is configured to receive one of the laminated glazing and the master holographic film assembly and Wherein the structure body includes a surface for contacting one of the laminated glazing and the master holographic film assembly that is not received by the channel.

3. The replication tool according to claim 2, wherein the surface for contacting one of the laminated glazing and the master holographic film assembly includes a shelf and a stop.

4. The replication tool according to claim 2, wherein the surface for contacting one of the laminated glazing, and the master holographic film assembly includes a flange.

5. The replication tool according to claim 1, wherein the structure body provides a separator between the laminated glazing and the master holographic film assembly.

6. The replication tool according to claim 1, wherein the base structure is configured to extend along the entire outer periphery of the laminated glazing.

7. The replication tool according to claim 1, wherein the base structure is made of an elastic material.

8. The replication tool according to claim 1, wherein the channel is configured to receive both of the laminated glazing and the master holographic film assembly.

9. The replication tool according to claim 8, wherein the structure body includes a port for attachment to a vacuum.

10. The replication tool according to claim 8, wherein a distance between the laminated glazing and the master holographic film assembly when the laminated glazing and the master holographic film assembly are positioned in the channel has a maximum rate of change of 1.0 mm over 100 mm.

11. The replication tool according to claim 8, wherein the distance between the laminated glazing and the master holographic film assembly when the laminated glazing and the master holographic film assembly are positioned in the channel has a maximum rate of change of 0.7 mm over 100 mm.

12. The replication tool according to claim 1, wherein the base structure forms a seal where the structure body meets the laminated glazing or the master holographic film assembly.

13. The replication tool according to claim 1, wherein the base structure further functions as a deairing ring.

14. A method of preparing a laminated glazing, comprising:
preparing a laminated glazing with a photopolymer film formed therein and a base structure on the laminated glazing;
aligning a master holographic film assembly with the laminated glazing wherein the master holographic film assembly contacts the base structure; and
treating the photopolymer film with a reactive light through the master holographic film assembly.

15. The method according to claim 14, wherein the base structure extends along an entire periphery of the laminated glazing.

16. The method according to claim 14, wherein the laminated glazing with the base structure is prepared by:
preparing a laminated glazing with a photopolymer film formed therein; and
attaching the base structure around the laminated glazing.

17. The method according to claim 14, wherein the laminated glazing with the base structure is prepared by:
preparing a stack of a first glass sheet, a first interlayer, the photopolymer film, a second interlayer, and a second glass sheet;
attaching the base structure around the stack;
deairing the stack; and
autoclaving the stack.

18. A method of preparing a laminated glazing, comprising:
preparing a laminated glazing with a photopolymer film formed therein;
attaching a base structure to a master holographic film assembly;
aligning the master holographic film assembly with the laminated glazing; and
treating the photopolymer film with a reactive light through the master holographic film assembly.

19. A method of preparing a laminated glazing, comprising:
preparing a laminated glazing with a photopolymer film formed therein;
attaching a base structure around the laminated glazing and a master holographic film assembly; and
treating the photopolymer film with a reactive light through the master holographic, film assembly.

20. The method according to claim 19, further comprising deairing a space between the laminated glazing and the master holographic film assembly before treating the photopolymer

21. The method according to any one of claims 14, 18, and 19, further comprising providing an index matching material between the laminated glazing and the master holographic film assembly before treating the photopolymer film.
